(19) United States
(12) Patent Application Publication
(10) Pub. No.: US 2020/0368754 A1
(43) Pub. Date: Nov. 26, 2020

(54) Plant Material Trimmer

(71) Applicant: Richard D. Grossman, Granada Hills, CA (US)

(72) Inventor: Richard D. Grossman, Granada Hills, CA (US)

(21) Appl. No.: 16/416,737

(22) Filed: May 20, 2019

(51) Int. Cl. B02C 23/16; A23N 15/00; B02C 18/14; B02C 23/02

(52) U.S. Cl. CPC B02C 23/16; A23N 15/00; B02C 2023/165; B02C 23/02; B02C 18/14

(57) ABSTRACT

A plant material trimmer (PMT) that cuts/separates plant leaf material from plant flower material. The PMT has a trimming assembly that includes a motor with a shaft. A propeller is attached to the motor shaft, above the motor. A twisted metal stand wire rope cutting element is attached to the propeller. An upward extending pin is located at each end of the propeller and the cutting element's ends interface with the pins. A trimming platform is located above the trimming assembly. The platform has multiple elliptical beveled slots extending therethrough. Above the platform is a conveyor assembly with a belt that rotates about two axles. A plurality of push panels are attached to the belt. A conveyor motor produces a forward movement of the belt and push panels which sweep across the platform. Wet or dry plant material is placed on the platform, and the push panels sweeping across the platform cause the plant material down through the slots. Upon exiting the slots the plant material is immediately cut by the rotating propeller and cutting element. The cut plant then falls into a mesh fabric bag located below.

### TECHNICAL FIELD

The invention generally pertains to plant and flower cutting and trimming devices, and more particularly to a plant material trimmer that effectively trims and separates wet and dry plant leaf and buds.

### BACKGROUND ART

In the industry of separating flowers or buds from their leaves, one of the most important apparatuses utilized for the processing of plants and plant material is typically referred to as a cutting or trimming machine. The design of these machines facilitates the cutting/trimming of unwanted plant leaf material from flower material. This cutting/trimming and separation of the plant leaf material from the flower material is required for the processing of certain plants, such as cannabis.

All cutting/trimming machines typically include a surface with openings through which the plant leaf material can pass, and a cutting blade/device that separate or cuts leaf material from the flower material. It is important to note that the trimming/cutting should be accomplished without damaging the inner flower material.

There are problems associated with the use of many conventional cutting/trimming machines. First as a result of the plant material being sticky, the machines require frequent cleaning to ensure proper and effective operation. The cleaning requirement typically results from the build-up of plant material on/in the surface and openings, and on the cutting tool. The cleaning must be done after each use of the machine, and sometimes as frequently as every two hours. The need for constant and frequent cleaning can have a significant impact on the production downtime.

Another problem that is common to many conventional trimming/cutting machines is that the plant leaf and flower material are subjected to a large amount of impact energy, the twister style machines are particularly prone to experiencing this problem. As a result of the damage to the flower material in particular from the impact energy, many growers of premium plants prefer to not use twister style machines because of this inherent problem.

The applicant's new machine does take advantage of acquired knowledge and produces a machine that provides significant improvements to this design and functionality of all conventional machines.

A search of the prior art did not disclose any literature or patents that read directly on the claims of the instant invention. However, the following U.S. patents are considered related:

| PATENT NO. | INVENTOR | ISSUED |
|---|---|---|
| 8,757,524 | Mosman | Jun. 24, 2014 |
| 2017/0232627 | Raichart | Aug. 17,017 |

The U.S. Pat. No. 8,757,524 discloses an apparatus for trimming plants, in particular, buds and flowers, to remove unwanted plant material. The apparatus employs a combination of a slotted metal drum and a lawn mower type cutting reel that are rotated in the same direction but at different speeds, to create a cutting interface that shears off the unwanted plant material. The apparatus further employs a vacuum manifold to collect the debris and transfer it into a waste collection device.

The 2017/0232627 publication discloses an apparatus that includes a box with specifically designed blades for cutting; a motor for rotating the blades over each other; a sweeper mechanism to gently move flowers around the enclosure blade; and a brush mechanism to gently tumble flowers over the blade surface.

For background purposes and indicative of the art to which the invention relates, reference may be made to the following remaining patents found in the patent search.

| PATENT NO. | INVENTOR | ISSUED |
|---|---|---|
| 7,168,643 | Mercier | Jan. 30,2007 |
| 2012/0279193 | Mosman | Nov. 8, 2012 |

### DISCLOSURE OF THE INVENTION

A plant material trimmer (PMT) that is designed to facilitate the trimming of unwanted plant leaf material from the plant flower or bud material. The PMT includes a trimming assembly with a trimming motor having an upward extending motor shaft, and two shaft collars that are placed around the motor shaft. Located above the motor is a propeller that is preferably made out of carbon fiber and having a center bore. A propeller is attached to the motor shaft, which causes the propeller to rotate when the motor is actuated. Longitudinally extending along the propeller is a wire rope cutting element, which is made of metal and had a first end and a second end. A securing member maintains the cutting element attached to the propeller. Located adjacent a first end of the propeller is a first upward extending magnetic pin, and located adjacent a second end of the propeller is a second upward extending magnetic pin. The wire rope cutting element first end interfaces with the first pin and the cutting element second end is interface with the second pin until motor speed increases to cutting speeds, at which time the cutting element is free-flying in the air.

Located above the trimming assembly is a trimming platform that is made of metal and has an upper surface and a lower surface. Extending through the trimming platform are a plurality of elliptically shaped slots.

A conveyor assembly is located above and extends longitudinally on the trimming platform upper surface. The conveyor assembly has a first side wall, a second side wall, at least one connecting member extending between the first side wall and second side wall, a first axle, and a second axle which are attached to the side wall via bearings. A first pulley is attached to the first axle and a second pulley is attached to the second axle. Interfacing with and extending around the two pulleys is a three-band belt. Equidistantly attached along the length of the belt are a plurality of push panels. As the belt rotates about the axles the push panels sweep across the trimming platform upper surface. A conveyor motor interfaces with the first axle and produces a forward movement of the push panels as the panels sweep across the platform's upper surface.

Plant material is placed on the trimming platform upper surface and the conveyor motor is actuated which causes the push panels to sweep across the platform. The push panels force the plant material to move across the platform. As the plant material moves, the material falls through the slots on the platform and is immediately cut and separated by the rotating wire rope cutting element and propeller. The propeller rotating produces a downward air force that pulls the plant material through the slots.

After the plant material is cut and separated, the resulting leaf material falls into a receptacle. The conveyor assembly is attached by at least one hinge which allows the conveyor assembly to each be raised to 90° upward position which facilitates cleaning the PMT as well as providing easy access to the components. The PMT uses a unique cutting apparatus that is a thin stainless steel cutting element rotating in a plane 0.003 to 0.010 inches beneath the slots on the stainless steel trimming platform. The rotational speed of the cutting element is adjustable, typically between 2000 and 3000 rpm depending on the nature and water content of plants. Centrifugal force pulls each half of the element outward, causing it to maintain its position under the platform. Use of the cutting element has several advantages. For example: it has a long life and if it shows signs of wear or is damaged it can be easily replaced and costs but a few dollars; whereas blades become dull, frequently need to be replaced or sharpened, typically cost several hundred dollars, and require partial disassembly of the machine to replace or sharpen. However, the major advantages of a rotating cutting element are that it is an excellent cutting agent, is superior to blades, and should resin build-up, it is easily cleaned by wiping with a rag. An additional improvement over existing trimming machines is that instead of using an accessory blower to pull air through the slots, the PMT uses a propeller, same length as the cable, located approximately ¾ of an inch below the cutting element Any resin which accumulates on the propeller is easily wiped off with a rag whereas cleaning a blade is a major undertaking.

In view of the above disclosure, the primary object of the invention is to produce a plant material trimmer that utilizes centrifugal and aerodynamic forces to facilitate the removal of unwanted plant leaf material from plant flower or bud material In addition to the primary object of the invention it is also an object of the invention to produce a plant material trimmer that:

provides superior cutting effect on a flower,

utilizes a cutting element that is economical and easy to replace,

is easy to use,

can cut/separate a large amount of plant material in a short time period,

is durable and long lasting,

is safe to use,

can be used for a variety of plants, and is optimal for use on cannabis,

can be quickly and easily cleaned after each use or when necessary,

is transportable,

requires little or no maintenance,

is cost effective from both manufacturer's and user's point of view.

These and other objects and advantages of the present invention will become apparent from the subsequent detailed description of the preferred embodiment and the appended claims taken in conjunction with the accompanying drawings.

### BRIEF DESCRIPION OF THE DRAWINGS

FIG. 1 is a front orthographic view of a plant material trimmer.

FIG. 2 is an exploded view of the plant material trimmer.

FIG. 3 is a rear orthographic view of a plant material trimmer.

FIG. 4 is a front elevational view of the plant material trimmer.

FIG. 5 is a rear elevational view of the plant material trimmer.

FIG. 6 is a right side elevational view of the plant material trimmer.

FIG. 7 is a left side elevational view of the plant material trimmer.

FIG. 8 is a top plan view of the plant material trimmer.

FIG. 9 is a bottom plan view of the plant material trimmer

FIG. 10 is a front orthographic view of a plant material trimmer showing a conveyor assembly in a raised position, exposing a trimming platform.

FIG. 11 is a top plan view of the plant material trimmer's propeller with a wire rope cutting element and two upward extending propeller pins.

FIG. 12 is a top detail view of the plant material trimmer's propeller center section with a motor shaft collar and a section of the wire rope cutting element.

FIG. 13 is a side detail view of the plant material trier's propeller center section with the motor shaft collar and a cutting element.

FIG. 14 is a bottom detail view of the plant material trimmer's propeller center with a bore, a motor shaft collar and two collar pins.

FIG. 15 is a side detail view of the plant material trimmer's trimming assembly including a trimming motor with a motor shaft.

FIG. 16 is an orthographic view of one of the plant material trimmer's push panels.

FIG. 17 is a front elevational view of one of the plant material trimmer's push panels.

FIG. 18 is a detail view of the plant material trimmer's conveyor motor drive system.

### BEST MODE FOR CARRYING OUT THE INVENTION

The best mode for carrying out the invention is presented in terms that disclose a preferred embodiment of a plant material trimmer (PMT). There are various types of plants that can be ingested by methods such as eating, smoking or inhaling after a plant is vaporized. The ingestion can be for medical/therapeutic purposes or for recreation. One plant that is utilized for both purposes is cannabis. As with many plants, cannabis grows as multiple stacks with leaves and flowers or buds. There are two major active ingredients in cannabis: cannabinoid (CBD) and tetrahydrocannabinol (THC) which produce the desired effects when ingested. The CBD and THC are significantly more concentrated in the plant bud. As a result, growers and sellers need to cut and separate the plant leaf material from the plant flower material. While this can be done by hand, it is extremely time consuming.

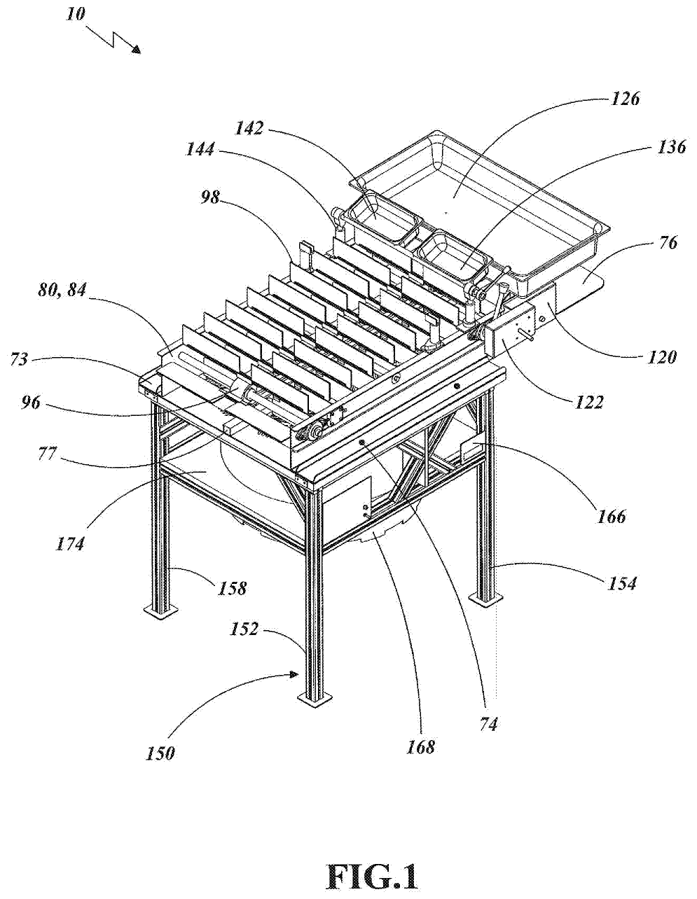

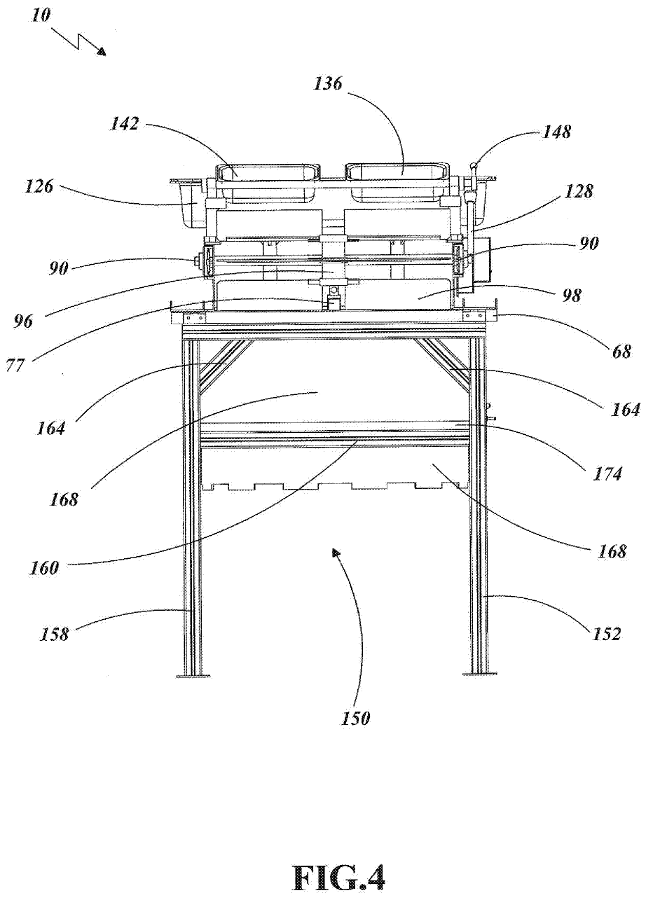

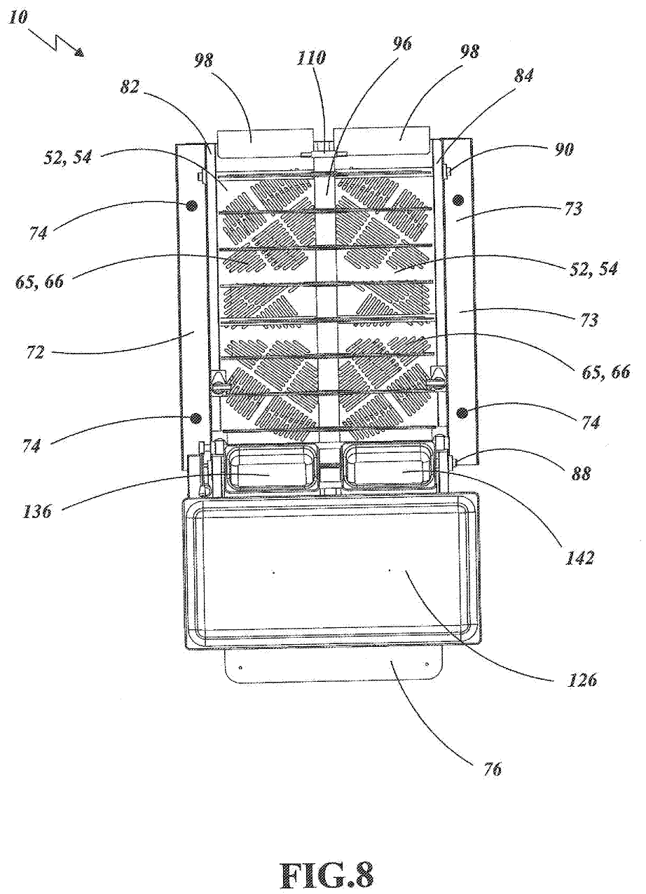

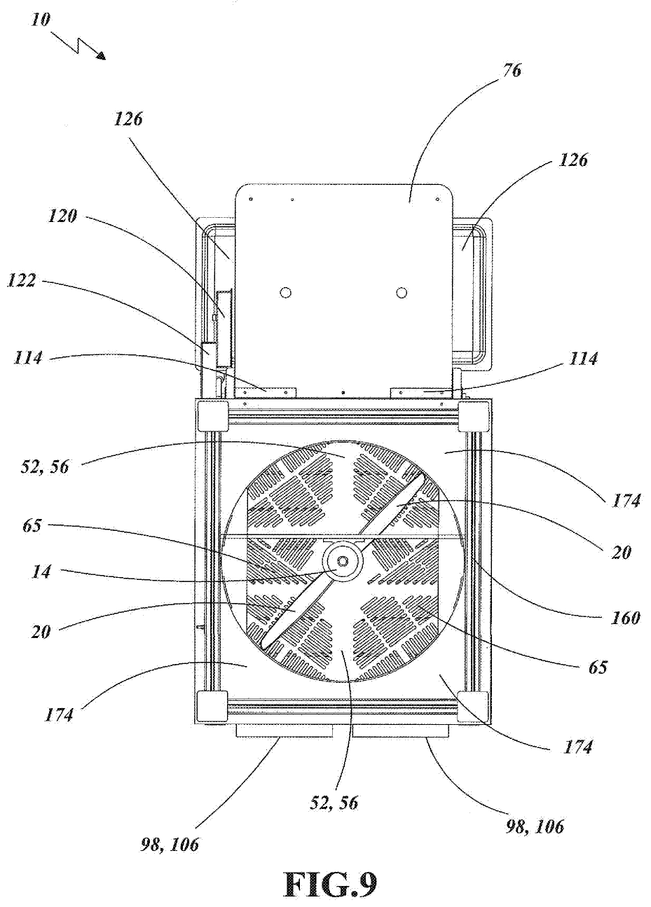

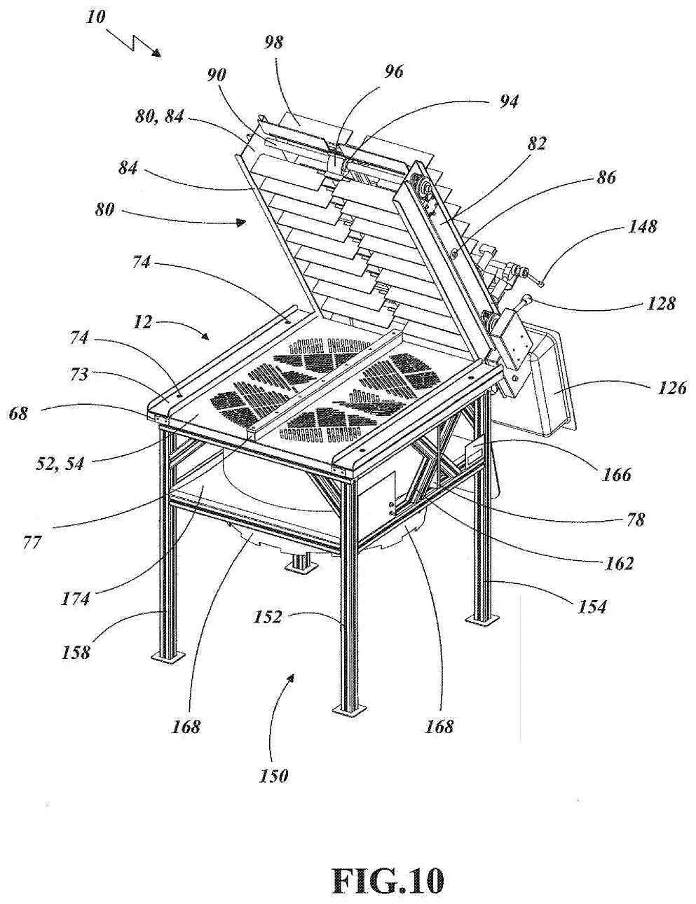

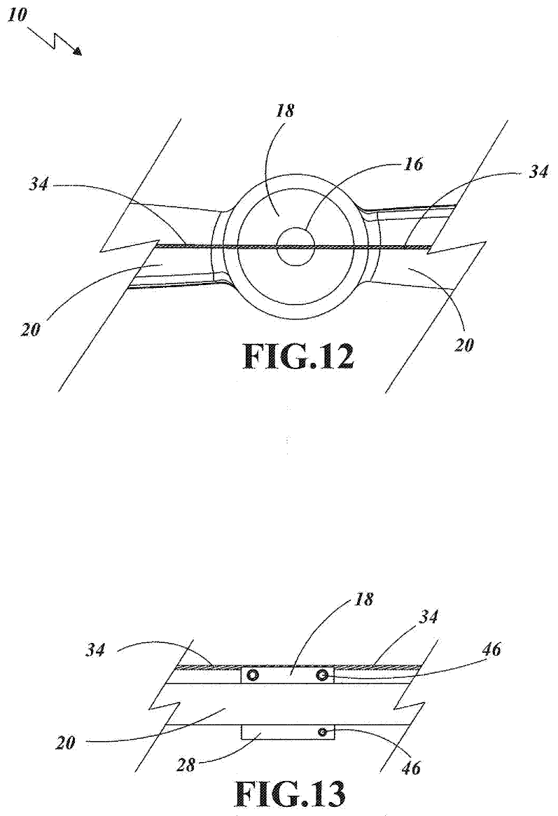

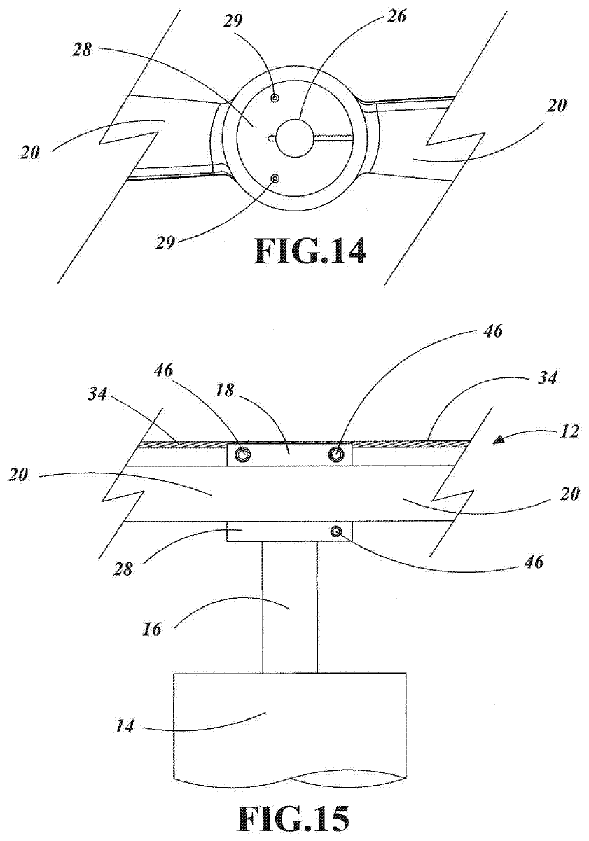

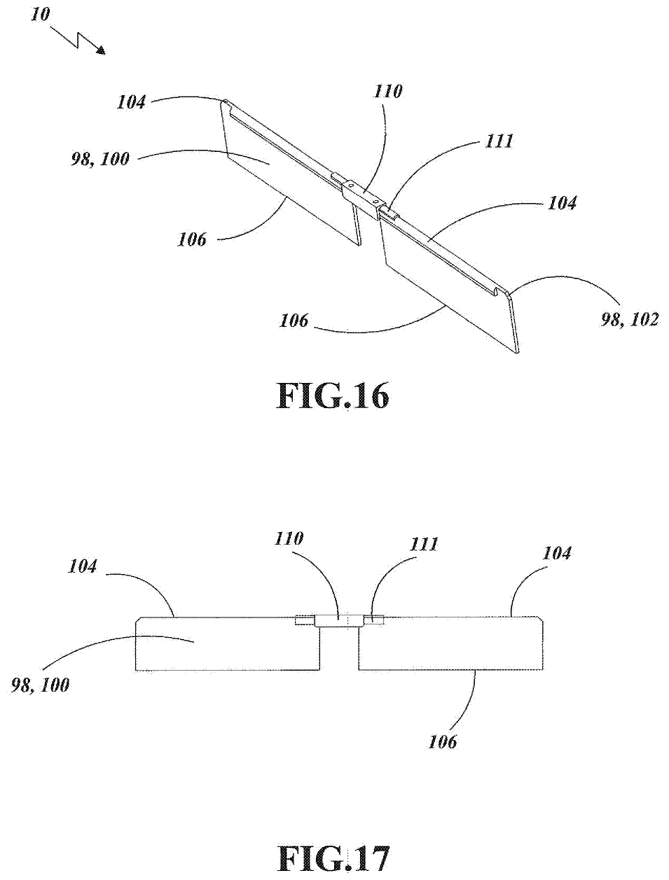

There are devices and machines, that cut/trim the plant material, but the devices/machines do have drawbacks as disclosed in the Background Art section. The applicant's new PMT 10, as shown in FIGS. 1-18, offers proprietary functionality that increases productivity while addressing the problems associated with prior art machines.

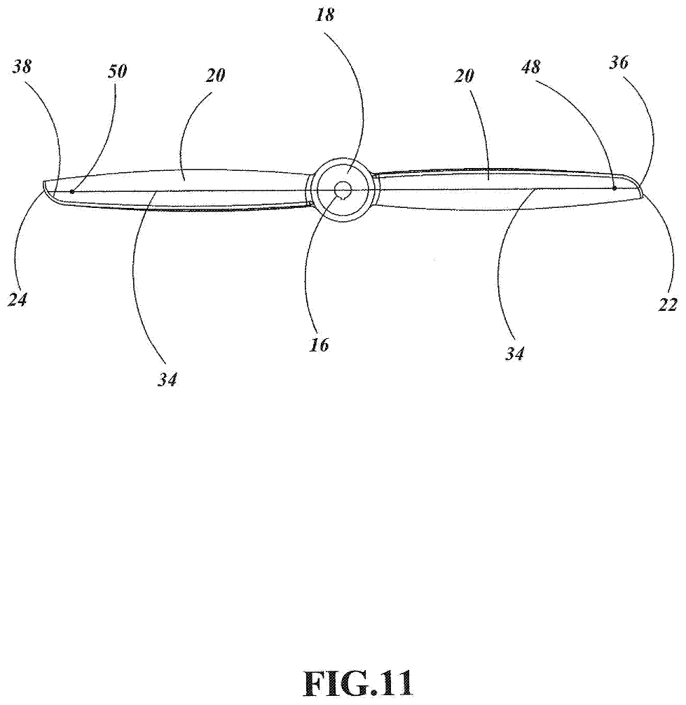

The PMT 10 is comprised of the following major element: a trimming assembly 12, a trimming platform 52, and a conveyor assembly 80. The trimming assembly 12, as shown in FIG. 17, includes a trimming motor 14 with an upward extending motor shaft 16. The motor 14 is preferably direct current (dc) variable speed drive motor powered from a utility power source and produces 2-5 hp. Located around the motor shaft 16 is a shaft collar 18. Supporting the motor 14 is a motor plate 78 that is mounted to two X-braces on a support structure (disclosed infra). Above the motor 14 is at least one propeller 20 having a center bore 26, a first end 22, a second end 24 and a propeller shaft collar 28 which utilizes collar pins 29 that extend through the collar into the propeller 20 interlock the propeller 20 to the motor shaft 16. The propeller 20, which is the type commonly used for model aircraft, is between 16-40 inches (40.64-101.6 cm) in diameter, and is preferably made of carbon fiber. Longitudinally extending along the propeller 20 is at least one wire rope cutting element 34, as shown in FIGS. 11, 12, 13 and 15, has a first end 36 and a second end 38. The distance between the cutting element 34 and the propeller 20 is typically between 0.01 to 0.03 inch. The wire rope cutting element 34 is purposefully thin and made of multiple twisted metal strands. The rotational speed of the cutting element 34 is 1500 RPM-4000 RPM. The shaft collar 18 maintains the cutting element 34 on the propeller 20. Once screwed on, the collar functions as a clamp on the cutting element 34. Located adjacent the first end 22 of the propeller 20 is a first upward extending pin 48, with the cutting element 34 interface with the first pin. Located adjacent the second end 24 of the propeller 20 is a second upward extending pin 50, with the cutting element 34 interface with the second pin. If desired, the cutting element 34 cam be treated with a non-stick coating such as titanium nitride and/or vegetable oil that is typically used on metal cutting tools; the no-stick coating prevents plant material from adhering to the cutting element and facilitates easier cleaning. It should be noted that the use of the propeller with the metal cutting element is one of the most important proprietary aspects of the PMT 10. This design and purpose has never been utilized for plant material cutting machines, and the increased functionality that results is a major improvement over any prior art machine.

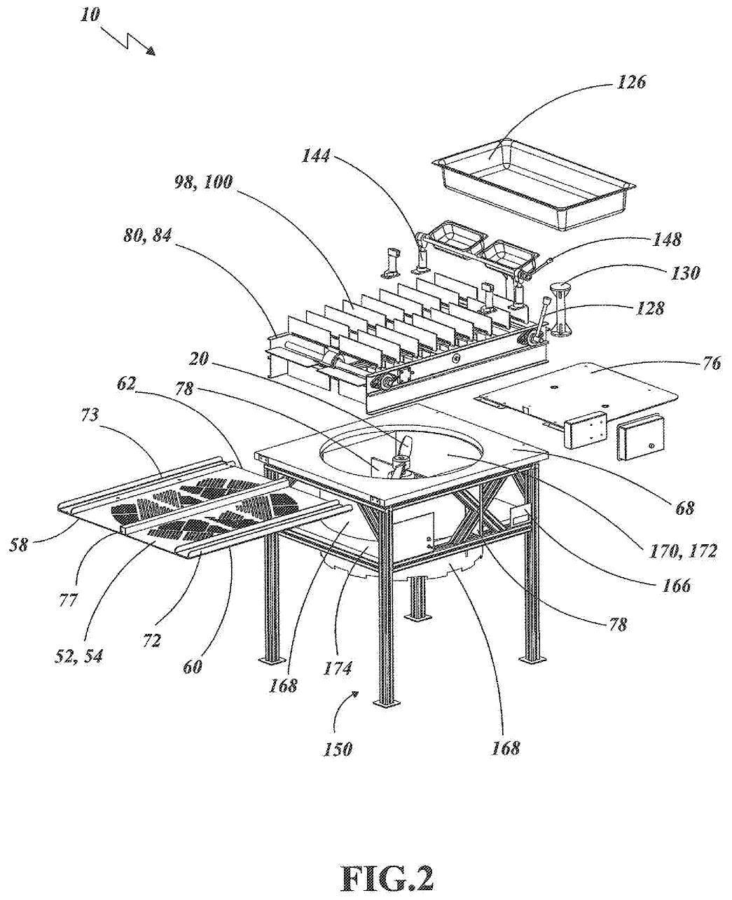

The trimming platform 52, as shown in FIGS. 2, 4, 5, 8, 9 and 10, is made of metal, preferably stainless steel, and has a substantially rectangular shape with an upper surface 54, a lower surface 56, a first side edge 58, a second side edge 60, a third side edge 62, and a fourth side edge 64. Extending through the trimming platform 52 is a plurality of slots 65 with beveled upper edges 66. The slots 65 are angularly positioned relative to plant material that moves along the trimming platform's upper surface 54. The slots 65 are dimensioned to allow a required quantity of plant material to fall through the slots, and to be small enough to prevent an average adult to not place his/her finger(s) through the slots 65, and to not allow a flower to protrude below the trimming platform. This is done as a safety measure to ensure a person does not insert their finger(s) through the slots 66 and being injured by the cutting element. Located below the platform 52 is a platform base 68 that provides support for the platform 52.

Attached permanently to the trimming platform 52 using adhesive and fasteners are three aluminum gusset components. These are utilized to ensure strength, flatness, structural integrity and stiffness requirements during operation. The struts also insure that when removing the trimming platform it remains flat and true.

There is one square center member 77 extending down the center on the trimming platform in the same direction as material flows and two aluminum U-channels 72,73 on the side edges of the assembly on the same axis as the center member. The two channels 72,73 are positioned just outside the conveyor assembly when the assembly is in a flat horizontal position.

The trimming platform is maintained on the support structure by securing knobs 74 that allow the operator to easily remove the trimming platform for cleaning. When the trimming platform is removed from the support structure, the main power is automatically disconnected within the trimming's 10 electrical circuit. This insures that the motor and propeller cannot move under power when the trimming platform is not covering the trimming assembly.

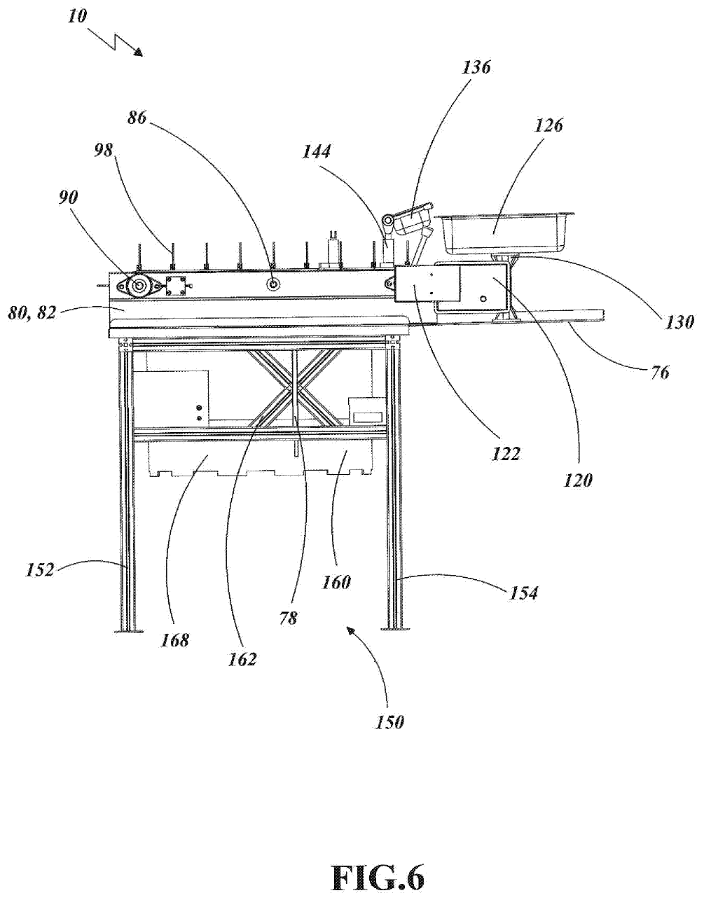

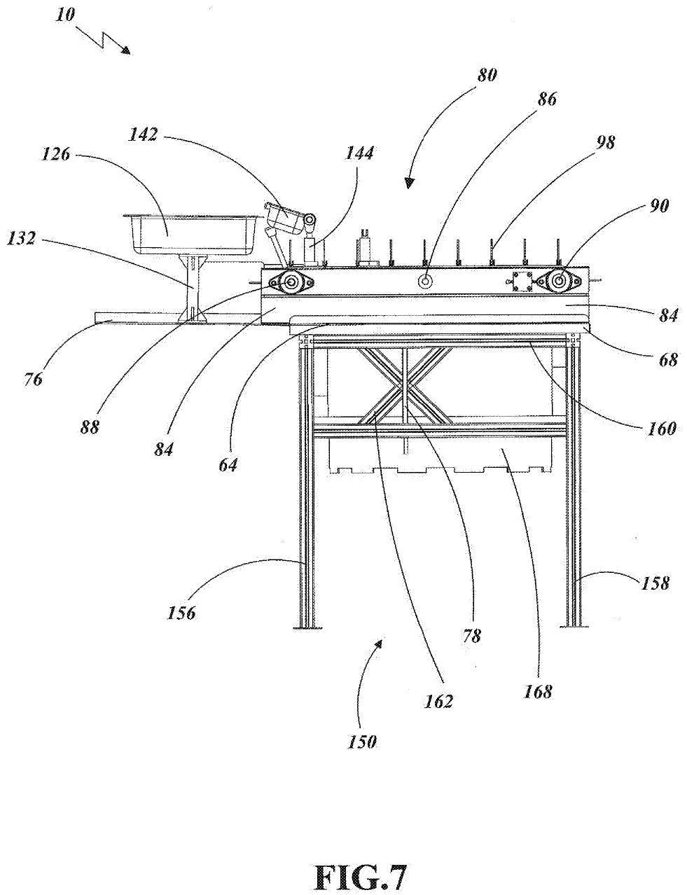

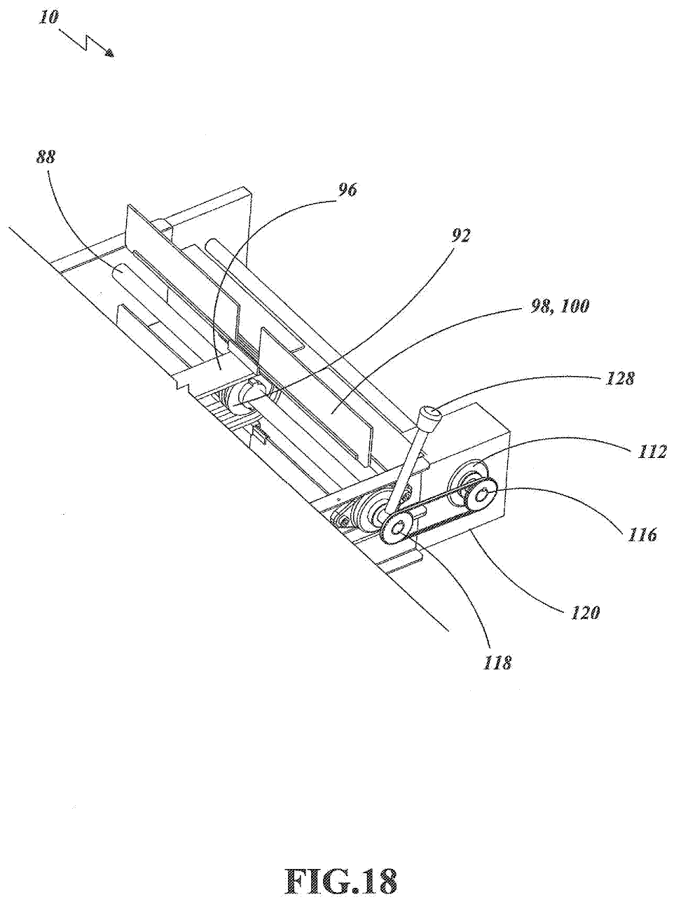

The conveyor assembly 80, as shown in FIGS. 1, 2, 3, 4, 5, 6, 7, 8 and 10, is located horizontally above and extends longitudinally on the trimming platform 52. The conveyor assembly 80 comprises a first side wall 82 that extends along the trimming platform's second side edge 60, a second side wall 84 that extends along the trimming platform's fourth side edge 64 opposite the first side wall 82, and at least one connecting member 86 extending between and attached by attachment means such as screws or bolt and nut to the first side wall 82 and second side wall 84. Once the connecting member 86 is attached, a frame structure is created for the conveyor assembly 80. The conveyor assembly also has at least one hinge 114 that allows the entire assembly to be raised for access to the trimming platform as well a cleaning and/or maintenance. The conveyor assembly 80 can also have at least one handle on a side opposite the hinge 114. By use of the handle and hinge, the conveyor assembly can be raised to an upright position, which is angularly opposite the raised trimming platform. Extending between the first and second side walls 82,84 are a first axle 88, as shown in FIG. 6, which functions as a drive axle and a second axle 90, as shown in FIG. 7. Attached at the substantial center of the first axle 88 is a first pulley 92, and attached at the substantial center of the second axle 90, in line with the first pulley, is a second pulley 94. As shown in FIG. 18, a three-band belt 96 interfaces with and extends around the two pulleys 92,94. Equidistantly attached along the length of the belt 96 are a plurality of push panels 98. The use of the three-band belt is specific because the belt is designed with three notches on the inner surface. This creates three separated sections on the belt inner surface. The center notch interfaces with the two pulleys, allowing the belt to rotate. The two outer sections are the area where each push panel's securing means are attached, without interfering with the operation of the belt on the pulleys. The push panels 98 are each shaped as elongated rectangles and are preferably made of styrene although other material such as plastic, nylon, rubber, wood or a composite could also be used. The push panels 98, as shown in FIGS. 1-8 and 10, each have an inner surface 100, an outer surface 102, an upper edge 104 and a lower edge 106, and are attached such that the lower edge 106 of each panel interfaces with the trimming platform's upper surface.

When the panels 98 are formed from flat styrene, each panel 98 is typically between 0.040 to 0.090″ in thickness, and are sheered and die cut to shape, with a bonding strip 109 of aluminum (bar) between 0.060 to 0.125″ in thickness and approximately 0.625″ tall×17″ long. Each panel is then wrapped with fiberglass embedded Teflon tape. This allows the panels to have an extremely high weight to strength ratio along with a tough non-stick surface for ease of cleaning. Each panel 98 also has two resilient members 111 attached to the top center section of the panel. This integrated component allows for the panels to easily press fit around a cleat fastener 110 and allows for removal of the panel from each cleat for cleaning. The panels and cleats can be easily cleaned while still attached to the conveyor belt assembly.

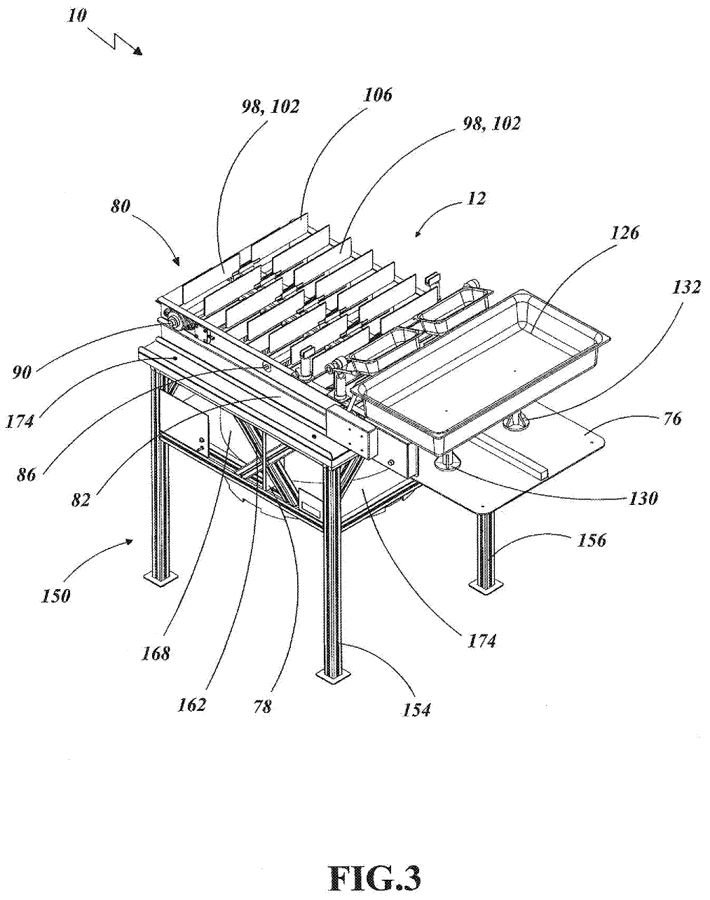

The push panels 98 are attached to the belt 96 by an attachment member 108 comprising the cleat fastener 110, as shown in FIGS. 3, 4, 5, 7, 8, 16 and 17. Also the push panels 98 can utilize male and female detents. The cleat fasteners 110 are aluminum “U style cleats that bolt directly to the conveyor belt 96, evenly spaced apart. The cleat design allows for the press fitting of the push panels 98 into a slot. A conveyor motor 112 supplies power to the first axle and is attached on a side of the conveyor assembly 80. As shown in FIGS. 1, 2, 6 and 18, there is an enclosure 120 that houses the motor 112 with a shaft protruding from the enclosure. A single directional sip bearing 116 is directly between the drive sprocket and the conveyor motor drive shaft. A second slip bearing 118 is mounted over the axle 88 and into a free floating rapid advance lever 128. This design allows for an operator to fast forward the conveyor or belt at any time without affecting the conveyor assembly motor. This capability is useful during set up, platform changing or inspection requirements.

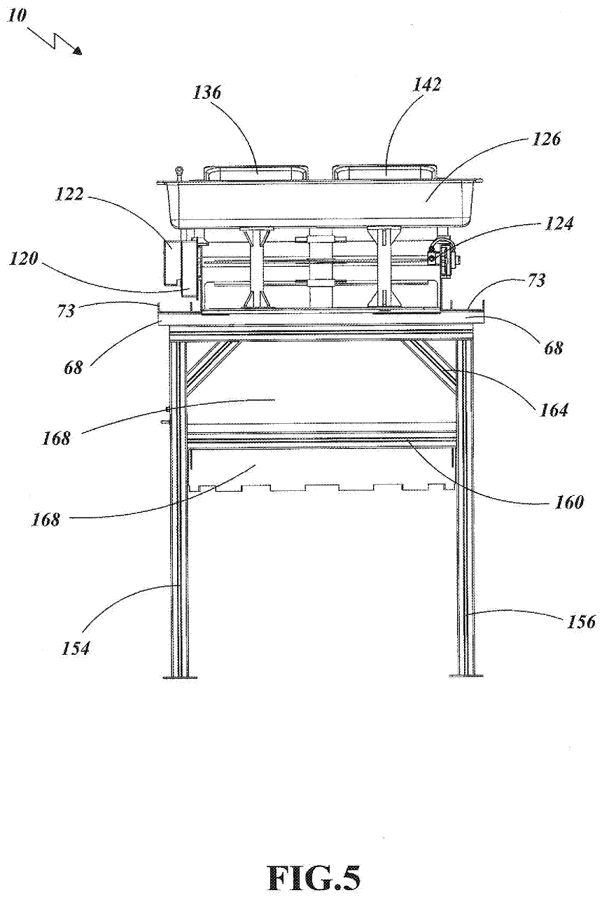

As shown in FIGS. 1-10, a material tray 126 is attached to the conveyor frame entry plate above the rear extension 76 and behind the conveyor assembly. At least one, and preferably a first 130 and second 132 tray supports, maintain the material tray 126 in position. In front of the material tray are first 136 and second 142 dump trays that can rotate 180 degrees from an upright position by means of a dump tray pivot support 144. An operator can hand feed each of the two dump trays from material contained within the material tray. While this is being done the conveyor assembly 80 is moving at an adjustable and desired rate of speed to process the material that is on the trimming platform 52. The belt 96 can be stopped at a specific position via a limit switch 124 mounted on the conveyor frame, as shown in FIG. 5.

When the belt 96 automatically stops, the dump trays 136,142 will rotate 180 degrees by means of a hand lever to dump the plant material directly onto the trimming platform. This takes place when the desired position is between two of the upper positioned and two lower positioned push panels, thereby providing clear access for the plant material to fall where desired onto the trimming platform 52. This occurs when the bottom two push panels are positioned straight up and down and resting on a lower edge, with light pressure on the trimming platform. This insures that plant material leaves are not caught between the edge of the push panel and the upper surface of the trimming platform because this would interfere with the rolling of the plant material over the trimming platform which is vital to efficient operation.

Plant material placed on the trimming platform's upper surface is swept across the surface and falls through the slots 65. The specific orientation and shape of each slot allows the plant material to roll and turn as the material is swept across the platform. The propeller 20 and cutting element 34 are located closely below the trimming platform 52 which ensures that as soon as the plant material exits the slot 65, the material is cut. The cutting element 34 utilizes centrifugal force to maintain the elements close proximity below the platform. Also, an aerodynamically created downward stream of air results from the propeller's rotation. The air stream draws the plant material downward through the slots. The propeller 20 also supports the cutting element during the ramp up and down rotation that occurs when the PMT 10 is in on and off cycles. The high speed rotating action of the propeller and cutting element cuts and separates the unwanted leaf material from the bud. One of the significant advantages of the PMT 10 cutting operation is that as a result of the high speed at which the cutting occurs there is little if any tearing or other negative impact on the flower/bud. This is highly desired for plants such as cannabis.

As shown in FIGS. 1-7 and 10, the PMT 10 is preferably placed on a support structure 150 including a first post 152, a second post 154, a third post 156, a fourth post 158 and eight horizontal members 160, two X-braces 162, and four angled supports 164.

The support structure is preferably made of profiled aluminum tubing in both 45 mm×90 mm and 45 mm×45 mm dimensions that bolts together easily using a threaded center hole and by milling counter bore holes 90 degrees from the center hole of each element that is bolted together. Also there are four lockable stem casters that screw directly into the bottom of each of the four vertical posts. This allows for a minimum footprint, expansion and ease of moving the trimmer 10 and locking it down in a desired position.

While a support structure is an important element, the structure shown is only one example. Many variations are possible for the support structure as long as the PMT 10 is securely and safety positioned during operation.

Once the plant material has been cut, the material falls into a receptacle 168 located below the trimming assembly, as shown in FIGS. 1, 2, 3 and 10. The receptacle 168 is comprised of either a metal or plastic semi-circular enclosure with a mesh fabric bag that clips onto the enclosure and allows air to pass through. This is important because the PMT 10 is capable of cutting both freshly-obtained or “wet” plant material and dry plant material. The receptacle is maintained in an upright position below the trimming assembly 12 by a receptacle support 174. Also, lining the inner surface(s) 170 of the receptacle are ultra high molecular weight (UMW) plastic sheet panels 172, as shown in FIG. 2. The panels 172 are easy to clean and replace when/if the need arises.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A plant material trimmer comprising:
a trimming assembly that includes:
a trimming motor with an upward extending motor shaft,
a propeller having a center bore,
a motor shaft that functions as a propeller shaft,
a propeller shaft collar that is placed around the motor shaft, and secured by collar pins,
a wire rope cutting element that longitudinally extends along the propeller, and including a first end and a second end,
a securing member that maintains the wire rope cutting element attached to the propeller,
a first upward extending propeller magnetic pin located adjacent a first end of the propeller, with the wire rope cutting element first end positioned on a surface of the first pin,
a second upward extending propeller magnetic pin located adjacent a second end of the propeller, with the wire rope cutting element second end positioned on a surface of the second pin, and
a trimming platform located above the trimming assembly and including an upper surface and a lower surface, the trimming platform having a plurality of slots extending through the trimming platform,
a conveyor assembly located above and extending longitudinally on the trimming platform upper surface, the conveyor assembly including:
a first side wall configured with a flat U-channel and shaft bearings,
a second side wall configured with a second U-channel and shaft bearings,
at least one connecting member extending between the first side wall and second side wall,
a center member,
a first axle,
a second axle,
a first pulley attached to the first axle,
a second pulley attached to the second axle,
a three-band belt that interfaces with and extends around the first pulley and second pulley,
a plurality of push panels that are equidistantly attached along the length of the three-band belt such that as the belt rotates about the axles the push panels produce a sweeping action across the trimming platform upper surface,
an enclosure encapsulating a drive motor and motor controls,
a motor shaft extending from the enclosure,
a first drive sprocket,
a first slip bearing that is configured between the motor shaft and first drive sprocket,
a second drive sprocket attached to the first axle,
a second slip bearing configured on the first axle, encapsulated by a shaft collar and having a slip bearing control lever,
a drive chain connected to the first drive sprocket and second drive sprocket,
a conveyor motor that interfaces with the first axle that produces movement of the push plates as the push panels sweep across the trimming platform upper surface,
a rear extension that extends outward from behind the conveyor assembly,
a material tray located above the rear extension and maintained in position by at least one tray support,
a first dump tray configured adjacent in front of the material tray,
a second dump tray configured adjacent and in front of the material tray, next to the first dump tray,
a dump tray rod,
a dump tray control lever.

2. The plant material trimmer, of claim 1 wherein the trimming platform slots are angularly positioned relative to plant material moving along the trimming platform upper surface.

3. The plant material trimmer, of claim 1 wherein the trimming platform slots further comprising beveled edges on an upper surface.

4. The plant material trimmer, of claim 1 wherein the three-band belt comprising three V-shaped notches, with a center notch interfacing with the first pulley and second pulley, and the design of the three-band belt providing width to facilitate the attachment by means of two fasteners that secure cleats to the three-band belt.

5. The plant material trimmer, of claim 1 further comprising a support structure that is comprised of:
a first post,
a second post,
a third post,
a fourth post.
eight horizontal cross members,
two X-braces,
four angled supports,
a revolutions per minute (RPM) display.

6. The plant material trimmer, of claim 1 wherein the conveyor assembly comprising at least one hinge that allows to be raised to an upward self-locking position.

7. The plant material trimmer, of claim 1 wherein the wire rope cutting element is made of twisted metal strands.

8. The plant material trimmer, of claim 1 further comprising a receptacle configured with ultra high molecular weight (UHMW) plastic sheet panels lining an inner surface of the receptacle.

9. A plant material trimmer comprising:
a trimming assembly that includes:
a trimming motor with an upward extending motor shaft,
a propeller having a center bore, a first end and a seconds end,
an enclosure encapsulating a drive motor and motor controls,
a motor shaft extending from the enclosure,
a first drive sprocket,
a first slip bearing that is configured between the motor shaft and first drive sprocket,
a second drive sprocket attached to the first axle,
a second slip bearing configured on the first axle, encapsulated by a shaft collar and having a slip bearing control lever,
a drive chain connected to the first drive sprocket and second drive sprocket,
a twisted metal wire rope cutting element that longitudinally extends along the propeller, and including a first end and a second end,
a securing member that maintains the wire rope cutting element on the propeller,
a first upward extending propeller pin located adjacent the first end of the propeller, with the wire rope cutting element placed against the first pin's magnetic surface,
a second upward extending propeller pin located adjacent the second end of the propeller, with the wire rope cutting element placed against the second pin's magnetic surface, and
a trimming platform that is located above the trimming assembly, the trimming platform is made of metal and is placed horizontally on top of the support structure, the trimming platform having:
an upper surface,
a lower surface,
a first side edge,
a second side edge,
a third side edge,
a fourth side edge, and
a plurality of slots with beveled upper edges, the slots extending through the trimming platform,
at least four securing knobs with bolts for maintaining or releasing the trimming platform,
a conveyor assembly located horizontally above and extending longitudinally on the trimming platform upper surface, the conveyor assembly comprising:
a first side wall extending along the trimming platform second side edge, and configured with a first U-channel and a shaft bearing,
a second side wall opposite the first side wall extending along the trimming platform fourth side edge, and configured with a second U-channel and a shaft bearing,
at least one connecting member extending between and attached by attachment means to the first side wall and second side wall,
a first axle extending between the first side wall and second side wall,
a second axle extending between the first side wall and second side wall,
a first pulley attached at the substantial center of the first axle,
a second pulley attached at the substantial center of the second axle,
a three-band belt that interfaces with and extends around the first pulley and second pulley,
a cleat member attached to the belt,
a plurality of push panels that are equidistantly attached along the length of the three-band belt such that as the belt rotates about the axles, the push panels produce a sweeping action across the trimming platform upper surface, each push panel having:
an upper edge,
a lower edge,
a center member,
an enclosure encapsulating a drive motor and motor controls,
a motor shaft extending from the enclosure,
a first drive sprocket,
a first slip bearing that is configured between the motor shaft and first drive sprocket,
a second drive sprocket attached to the first axle,
a second slip bearing configured on the first axle, encapsulated by a shaft collar and having a slip bearing control lever,
a drive chain connected to the first drive sprocket and second drive sprocket,
a conveyor motor that interfaces with the first axle and produces a forward movement of the push panels as the push panels sweep across the trimming platform upper surface, and
a rear extension that extends outward from behind the conveyor assembly.

10. The plant material trimmer, of claim 9 wherein the trimming platform slots are angularly positioned in a varying arrangement relative to plant material moving along the trimming platform upper surface.

11. The plant material trimmer, of claim 9 wherein the three-band belt comprising three V-shaped notches, with the center notch interfacing with the first pulley and second pulley, and the design of the three-band belt providing width to facilitates the attachment by means of two fasteners on the cleat to the belt.

12. The plant material trimmer, of claim 9 wherein the conveyor assembly comprising at least one hinge that allows the conveyor assembly to be raised to an upward self-locking position.

13. The plant material trimmer, of claim 11 wherein the push plate is made of a material selected from the group consisting of styrene, wood, plastic, nylon, rubber and a composite.

14. The plant material trimmer, of claim 9 further comprising a support structure that is comprised of:
a first post,
a second post,
a third post,
a fourth post,
eight horizontal cross members,
two X-braces,
four angled supports.

15. The plant material trimmer, of claim 9 further comprising a receptacle that is located below the trimming platform and trimming assembly for trimmed and separated plat material that is processed through the plant material trimmer, the receptacle having at least one ultra high molecular weight (UHMW) plastic sheet panel lining inner surfaces of the receptacle.

16. The plant material trimmer, of claim 15 wherein the receptacle is configured as a semi-circular enclosure.
